(19) United States
(12) Patent Application Publication
(10) Pub. No.: US 2016/0063206 A1
(43) Pub. Date: Mar. 3, 2016

(54) SECURE ONLINE HEALTH SERVICES

(71) Applicant: Asset Health MD, LLC, Troy, MI (US)

(72) Inventor: David Edward WILSON, Bloomfield Hills, MI (US)

(21) Appl. No.: 14/469,914

(22) Filed: Aug. 27, 2014

(51) Int. Cl. G06F 19/00

(52) U.S. Cl. CPC G06F 19/3431; G06F 19/3418

(57) ABSTRACT

A system may include a computing device configured to access a patient record including screening information indicative of vital signs of a patient and questionnaire information indicative of health history of the patient, determine, using a risk engine based on the screening information and the questionnaire information, risk allocations for the patient that define a primary health risk of the patient, and identify, according to the risk allocations, at least one online course and personal goal to be prescribed to the patient to reduce the primary health risk of the patient toward a health goal.

### TECHNICAL FIELD

Aspects as disclosed herein generally relate to a secure online health system for providing health services and monitoring to patients by physicians.

### BACKGROUND

For many patients, interaction with a physician is limited to periodic check-ups or unexpected illnesses. A physician may wish to monitor a patient to ensure wellness between visits. However, such interaction may cause a patient to incur undesirable co-pays or missed work, or the patient may decline the monitoring, not seeing a need or useful result.

### SUMMARY

In a first illustrative embodiment, a system includes a computing device configured to access a patient record including screening information indicative of vital signs of a patient and questionnaire information indicative of health history of the patient, determine, using a risk engine based on the screening information and the questionnaire information, risk allocations for the patient that define a primary health risk of the patient, and identify, according to the risk allocations, at least one online course and personal goal to be prescribed to the patient to reduce the primary health risk of the patient toward a health goal.

In a second illustrative embodiment, a system includes a patient computing device configured to provide, via a patient portal provided by a remote computing device to the patient computing device over a communication network, questionnaire information indicative of a health history of a patient, receive, from the remote computing device, a notification to attend a follow-up visit to a physician office to review a personal health assessment report generated by the remote computing device based on the questionnaire information and screening information indicative of vital signs of the patient collected at an initial patient visit to the physician office, and receive, via the patient portal, at least one online course and personal goal prescribed to the patient by the physician to reduce a primary health risk of the patient, the at least one online course and personal goal determined based on the questionnaire information, the screening information, and input from the physician responsive to the initial patient visit and follow-up visit.

In a third illustrative embodiment, system includes an administrator computing device configured to receive, via an administrator portal provided by a remote computing device to the administrator computing device over a communication network, information indicative of at least one online course and personal goal suggested by the remote computing device to be prescribed to a patient to reduce a primary health risk of the patient toward a health goal, and provide, via the administrator portal, physician approval of the at least one online course and personal goal to be prescribed to the patient, to cause the remote computing device to update a patient portal, provided by the remote computing device to a patient computing device over the communication network, to indicate that the at least one online course and personal goal are prescribed to the patient.

### BRIEF DESCRIPTION OF THE DRAWINGS

FIG. 1 illustrates an health system for providing secure online health services for patients;

FIG. 2 illustrates a process for patient registration using the health system;

FIG. 3 illustrates a process for patient enrollment into the services of the health system;

FIG. 4 illustrates a process for updating health measures information for a patient using the health system;

FIG. 5 illustrates a process for receiving health assessment information by the health system using a questionnaire;

FIG. 6 illustrates a process for reviewing and setting goals using the health system; and

FIG. 7 illustrates a process for ongoing communications with the patient using the health system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A health system may provide secure online health services for a patient. These secure online health services may include handling aspects of patient interaction with a physician or other medical support staff. Using the health system, the patient may achieve a more active relationship with his or her physician. For example, the patient may enroll in health programs to learn about his or her health and health conditions, track nutrition and physical activity, set personal health goals, and otherwise communicate with his or her physician. The health system may also be managed by one or more system administrators, such as the physician or a nurse, clerk or another member of support staff, that may interact with the health system to facilitate program activities.

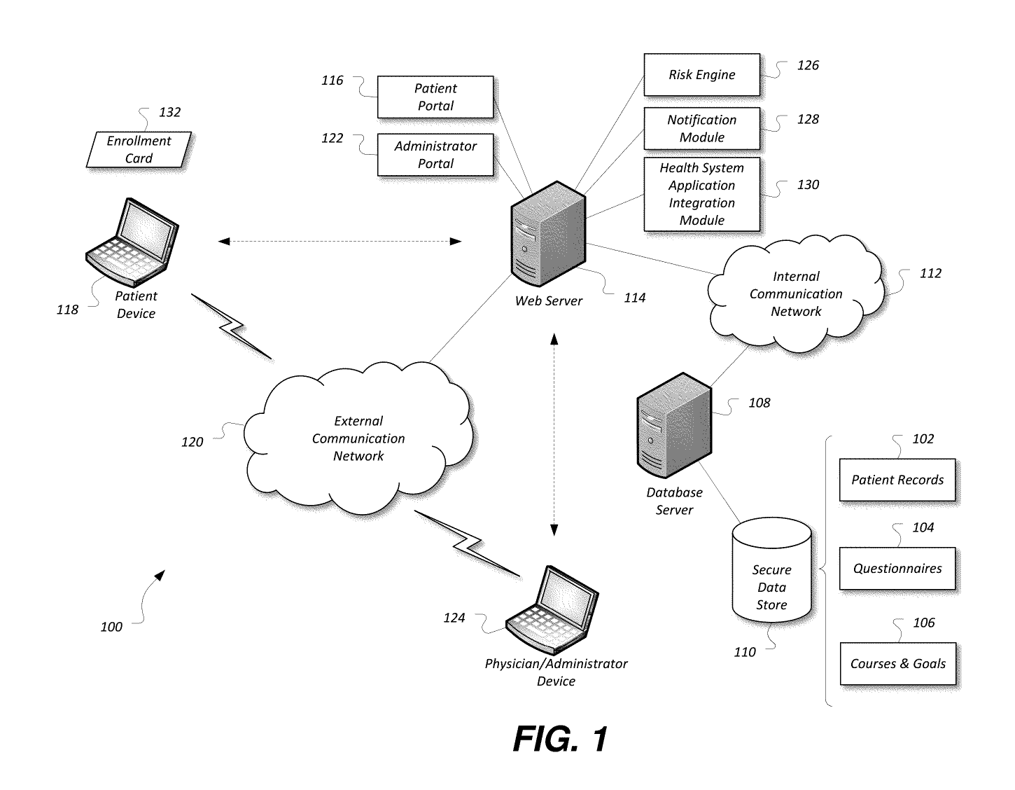

FIG. 1 illustrates a health system 100 for providing secure online health services to patients. As illustrated, the system 100 includes a database server 108 hosting a secure data store 110 maintaining patient records 102, questionnaires 104, and courses and goals 106. The system 100 further includes a web server 114 having a risk engine 126, a notification module 128, a health system application integration module 130, and an administrator portal 122. The web server 114 may be configured to access the database server 108 over an internal communication network 112. Using the secure data store 110, the web server 114 may be configured to maintain a patient portal 116 accessible to patient devices 118 and the administrator portal 122 accessible to physician/administrator devices 124 over an external communication network 120. As explained in detail below, the health system 100 may be configured to receive enrollment of patients from the patient devices 118 according to enrollment cards 132, identify risks for the patients using the risk engine 126 according to questionnaire 104 input and the patient records 102, and recommend which of the courses and goals 106 to be prescribed to the patients for monitoring via the health system 100.

The patient records 102 may include information gleaned from an initial health status or screening of the patient. The patient records 102 may include, for example, measurements of patient vitals such as blood pressure, pulse rate, weight, height, age, sex, recent illnesses, and currently prescribed medications. In many cases the patient records 102 are captured from a patient by medical personnel at a physician's office when the patient appears for a check-up or other visit. The patient records 102 may further include additional information regarding the patient, such as home address, insurance information, phone number and e-mail address.

The patient records 102 may also include system state information indicative of the status of the patient with the health system 100. For example, the patient records 102 may indicate whether or not the patient is registered with the health system 100, whether or not the patient is enrolled with the health system 100, and a number of days since or a date of the last communication between the health system 100 and the patient.

The questionnaires 104 include one or more series of questions configured to identify information about patients that may not be identifiable from the patient records 102 or initial health screening. The topics of the questionnaire 104 may relate to items such as the patient's exercise habits, the patient's sleep habits, the level of physical activity undertaken by the patient, and the patient's family history for various conditions, such as cardiovascular illness or diabetes. In some cases, the questions of the questionnaires 104 may be multiple-choice questions, where a patient selects a best answer from a set of given answers. In other cases, the questionnaires 104 may include free-form questions, where a patient writes in or otherwise provides an answer. The questionnaires 104 may include one or more questions that may be included in or excluded from the questionnaire 104 according to the patient records 102. For example, if the health system 100 deems a patient to be overweight or obese (e.g., according to height and weight information included in the patient records 102), a questionnaire 104 including questions related to diet or exercise may be utilized to identify patient information in those areas.

The courses and goals 106 may include information useful for helping a patient with improving one or more aspects of the patient's health. The goals portion of the courses and goals 106 may include, for example, one or more specific measures of an objective health parameter that a patient may attempt to achieve. As some possibilities, goals may include weight, calorie intake, exercise, and resting heart rate. The courses portion of the courses and goals 106 may include suggested actions to be performed by the patient or information to be provided to the patient to help the patient in achieving the goals portion of the courses and goals 106.

The database server 108 may include various types of computing apparatus, such as a computer workstation, a server, a desktop computer, a virtual server instance executed by a mainframe server, or some other computing system and/or device. Computing devices, such as the database server 108, generally include a memory on which computer-executable instructions may be maintained, where the instructions may be executable by one or more processors of the computing device. Such instructions and other data may be stored using a variety of computer-readable media. A computer-readable medium (also referred to as a processor-readable medium or storage) includes any non-transitory (e. g., tangible) medium that participates in providing data (e.g., instructions) that may be read by a computer (e.g., by the processor of the database server 108). In general, processors receives instructions, e.g., from the memory via the computer-readable storage medium, etc., and executes these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Java Script, Perl, PL/SQL, etc.

The secure data store 110 may be one such application included on the storage of the database server 108. The secure data store 110 may include instructions that, when loaded into memory and executed by the database server 108, cause the database server 108 to perform database functionality including the storage, update, and retrieval of relational information. Databases or data repositories such as the secure data store 110 may include various kinds of mechanisms for storing, accessing, and retrieving various kinds of data, including a hierarchical database, a set of files in a file system, an application database in a proprietary format, a relational database management system (RDBMS), etc. The secure data store 110 may employ features of the computer operating system of the database server 108, and may be accessed via the internal communication network 112 in a variety of manners. The secure data store 110 may also utilize the file system via the computer operating system, and may store and retrieve include files stored in various formats. An RDBMS generally employs the known Structured Query Language (SQL) in addition to a language for creating, storing, editing, and executing stored procedures, such as the PL/SQL language mentioned above. More specifically, the secure data store 110 may be configured to maintain information including the patient records 102, questionnaires 104 and courses and goals 106.

The internal communication network 112 may be configured to facilitate secure communication between internal devices of the health system 100. Accordingly, the internal communication network 112 may provide communication services between the database server 108 and the web server 114. As one aspect of providing security for the communications, the internal communication network 112 may limit or exclude communications from devices other than the internal devices (e.g., database server 108 and the web server 114). Thus, the secure data store 110 may be configured to maintain information such that it may be accessible only to authorized parties. Additionally or alternately, the internal communication network 112 may be configured to support encryption of communications between the internal devices.

Similar to as discussed above with respect to the database server 108, the web server 114 may include various types of computing apparatus including a memory on which computer-executable instructions may be maintained, where the instructions may be executable by one or more processors of the computing device. The web server 114 may be configured to maintain the patient portal 116 accessible to patient devices 118 and the administrator portal 122 accessible to physician/administrator devices 124 over the external communication network 120. In an example, the web server 114 may be configured to provide the patient portal 116 and administrator portal 122 by using a web server application. As another possibility, the web server 114 may execute a health services server application that may be accessed by a dedicated client application of a connecting device.

The patient portal 116 may be an application or library included on the storage of or otherwise accessible by the web server 114. The patient portal 116 may include an interface to the health system 100 provided by the web server 114 and accessible by patients. When accessed, the patient portal 116 may be configured to allow the patient to access, view, and update aspects of the information maintained by the secure data store 110, including the questionnaires 104 and the courses and goals 106 corresponding to the patient.

In some cases, the patient portal 116 may be branded according to a physician's office. For instance, the patient portal 116 may include images, text or other elements related to a physician's office of the accessing patient. As one approach to allowing the web server 114 to distinguish among different physician/administrator sites e.g., to provide the correct patient information and branding for the accessing patient, an identifier of the physician's office may be included in a URL used to access the patient portal 116. To do so, the URL may include a name or other identifier of the physician office as a subdomain or parameter.

The patient devices 118 may include various devices usable by patients to access the patient portal 116 provided by the web server 114 over the external communication network 120. The external communication network 120 may include one or more interconnected communication networks such as the Internet, a cable television distribution network, a satellite link network, a local area network, a wide area networks, and a telephone network, as some non-limiting examples. The patient devices 118 may include laptop computers, tablet or other handheld computers, mobile phones, computer workstations, servers, desktop computers, or some other computing system and/or device. In an example, the patient devices 118 may be configured to access the patient portal 116 by using a web browser application. As another possibility, the patient devices 118 may execute a health services application, or “app”, configured to provide access to the patient portal 116 (e.g., as downloaded from an application store such as the App Store provided by Apple, Inc.

The administrator portal 122 may be another application or library included on the storage of or otherwise accessible by the web server 114. The administrator portal 122 may include an interface to the health system 100 provided by the web server 114 and accessible by system administrators such as physicians and nurses. When accessed by the administrator, the administrator portal 122 may be configured to allow users to access aspects of the information maintained by the secure data store 110 that is useful for the administrators, such as patient results to questionnaires 104, patient records 102, recommendations for courses and goals 106 to prescribe to the patient, and status information regarding patient progress with the courses and goals 106. Similar to the patient devices 118, the administrator devices 124 may include various devices usable by administrators to access the administrator portal 122 provided by the web server 114 over the external communication network 120. Also similar to the patient devices 118, the administrator devices 124 may include laptop computers, tablet or other handheld computers, mobile phones, computer workstations, servers, desktop computers, or some other computing system and/or device.

The risk engine 126 may be an application or other computer-executable instructions included on the storage of or otherwise accessible by the web server 114. The risk engine 126 may include instructions that, when loaded into memory and executed by the web server 114 or other computing device accessible to the web server 114, cause the device to access patient records 102 including screening information indicative of vital signs of a patient and questionnaire 104 information indicative of health history of the patient, determine, based on the information of the patient records 102 and the questionnaire 104 responses, risk allocations for the patient that define a primary health risk of the patient, and identify, according to the risk allocations, at least one course and goal 106 to be prescribed to the patient to reduce the primary health risk of the patient toward a health goal.

The notification module 128 may be another application or computer-executable instructions included on the storage of or otherwise accessible by the web server 114. The notification module 128 may include instructions that, when loaded into memory and executed by the web server 114 or other computing device accessible to the web server 114, cause the device to provide notification messages to patients or administrators. For patient notifications, the notification messages may be sent to contact information for the patients included in the patient records 102, such as phone number or e-mail address. For administrator notifications, the notification messages may be sent to contact information for the physician's offices maintained by the health system 100 (e.g., in the data store 110), such as phone numbers and e-mail addresses.

The health system application integration module 130 may be another application or library included on the storage of or otherwise accessible by the web server 114. The health system application integration module 130 may include instructions that, when loaded into memory and executed by the web server 114 or other computing device accessible to the web server 114, cause the device to integrate the health system 100 with emergency health records or other types of medical records electronically accessible from outside systems. For example, the health system application integration module 130 may be configured to securely retrieve records related to the patient (e.g., according to information retrieved from the patient records 102) from a third party or other associated records system, such as the records system of a hospital.

The enrollment cards 132 may include information provided to the patient indicative of information that may be used to allow the patient to commence enrollment with the health system 100. For example, the enrollment cards 132 may include information such as a URL or other address of the web server 114 (e.g., an address of a physician-branded patient portal 116) that may be input into the patient device 118 to allow the patient device 118 to access the patient portal 116.

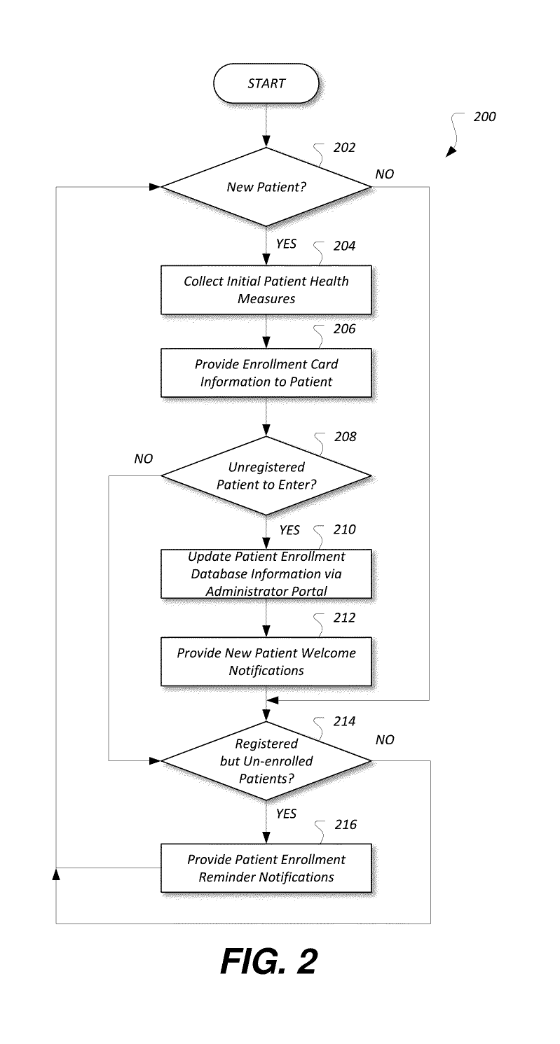

The health system 100 may be configured to receive enrollment of patients from the patient devices 118 according to enrollment cards 132, identify risks for the patients using the risk engine 126 according to user input to the questionnaires 104 and the patient records 102, and recommend which of the courses and goals 106 to be prescribed to the patients for monitoring via the health system 100. Further aspects of enrollment, registration, assignment and tracking of courses and goals 106 and patient notification are discussed in detail with respect to the FIGS. 2-7 below.

FIG. 2 illustrates a process 200 for patient registration using the health system 100. The process 200 may be performed, for example, by the administrator portal 122 of the web server 114 receiving input from the administrator device 124. The process 200 may be initiated, for example, by a patient agreeing to participate in the health system 100, based on promotion of the health system 100 during the office visit by an administrator of the health system 100. This office visit in which the patient aggresses to participate may be referred to as a first visit or initial visit.

At operation 202, the administrator portal 122 determines whether a new patient is to be added to the health system 100. For example, based on administrator access to the administrator portal 122 of the web server 114 using the administrator device 124, the administrator portal 122 may query the secure data store 110 for patient records 102 related to the patient to be potentially added (e.g., by querying by social security number (SSN), patient name, etc.). If no patient records 102 for the patient exist, control passes to operation 204. Otherwise, control passes to operation 214.

At operation 204, the administrator portal 122 collects initial patient health measures for the patient. For example, the administrator may collect the initial patient health measures during the physician appointment, and the administrator portal 122 may receive the information via the administrator portal 122 from the administrator. The administrator portal 122 may further receive additional information regarding the patient unrelated to patient health, such as e-mail address, phone number, and medical record number. The administrator portal 122 may accordingly utilize the received information to create a new patient record 102 in the secure data store 110. The new patient record 102 may be set to a state of unregistered (sometimes referred to as pre-registered), meaning that the initial patient health data is included in the patient record 102, but the patient has not registered or enrolled with the health system 100.

At operation 206, the administrator portal 122 provides the enrollment card 132 to the patient. For example, the administrator portal 122 may provide information that may be transferred to the enrollment card 132, such that the patient may use the transferred information to access the health system 100 via the patient portal 116. The transferred information may include, for example, a web or other address of the web server 114 that may be input into the patient device 118 to allow the patient device 118 to access the patient portal 116. Additionally or alternately, the transferred information may include a name of the patient, a unique identifier of the patient for use by the system, and an initial password or other credentials (e.g., social security number, insurance information, etc.) that may be used to allow the patient to initialize their account via the patient portal 116.

At operation 208, the administrator portal 122 determines whether there are unregistered patients to enter. For example, at a predetermined interval the administrator portal 122 may query the secure data store 110 for patient records 102 set to the state of unregistered. If unregistered patient records 102 are located, control passes to operation 210. Otherwise, control passes to operation 214.

At operation 210, the administrator portal 122 updates patient enrollment database information. For example, the administrator may access the administrator portal 122 of the health system 100 using the administrator device 124 (e.g., to browse to an HTTPS web location of the administrator portal 122 provided by the web server 114). The administrator portal 122 may authenticate the administrator device 124 (e.g., based on credentials input by the administrator). Once authenticated, the administrator portal 122 may provide a listing of the patient records 102 set to the state of unregistered. The administrator portal 122 may further receive entry of information for each of the listed patient records 102 (e.g., the details of the initial patient health measures collected during the physician appointment) to confirm the patient record 102 and place the patient records 102 into a registered state.

At operation 212, the administrator portal 122 provides new patient welcome notifications. For example, for each patient record 102 that is updated at operation 210, the administrator portal 122 may provide a notification to the patient instructing the patient to visit the patient portal 116 of the health system 100. The administrator portal 122 may utilize the notification module 128 of the web server 114 to provide the notification to an address of the patient (e.g., e-mail address) indicated by the corresponding patient records 102. The notification may include instructions requesting the patient to access the patient portal 116.

At operation 214, the administrator portal 122 determines whether there are registered, but un-enrolled patients awaiting enrollment. For example, at a predetermined interval, the administrator portal 122 may query the secure data store 110 for patient records 102 that are registered but set to the state of un-enrolled, and who have received their last communication at least a predetermined period of time ago. In one example, the query interval may be nightly, and the period from last communication may be three days. If un-enrolled patient records 102 are located, control passes to operation 216. Otherwise, control passes to operation 202 to perform patient registration for additional patients.

At operation 216, the administrator portal 122 provides patient enrollment reminder notifications. The administrator portal 122 may utilize the notification module 128 of the web server 114 to provide the notification to an address of the patient (e.g., e-mail address), as indicated by the corresponding patient records 102. The notification may include renewed requests for the patient to access the patient portal 116. The notification may further include additional information, such as a message explaining the benefits of the health system 100. After operation 216, control passes to operation 202 to perform patient registration for additional patients.

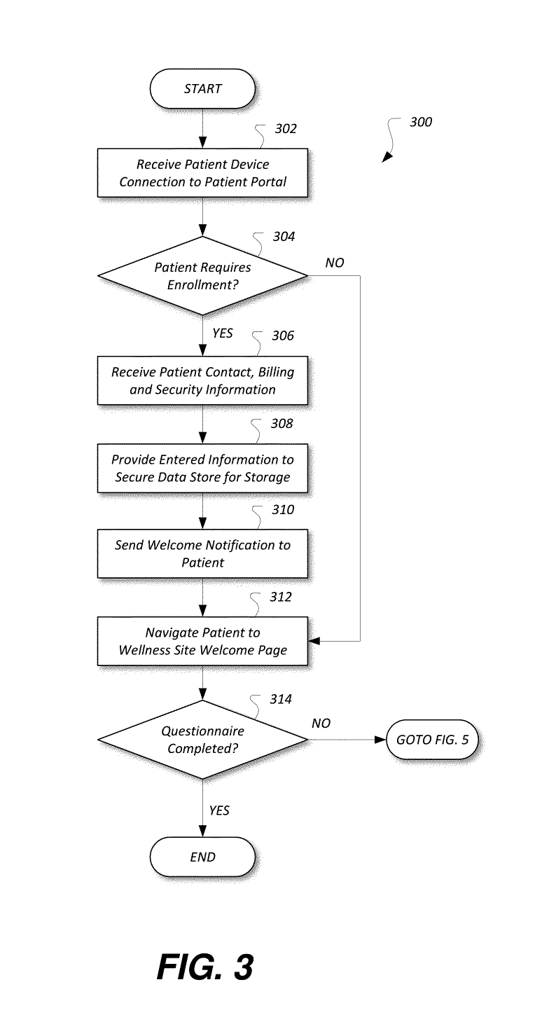

FIG. 3 illustrates a process 300 for patient enrollment into the services of the health system 100. The process 300 may be performed for example, by the administrator portal 122 of the web server 114 receiving input to the patient portal 116 from the patient device 118.

At operation 302, the administrator portal 122 receives a patient device 118 connection to the patient portal 116 of the web server 114. For example, the patient may use a URL or other identifier of the web server 114 to cause the patient device 118 to connect to the patient portal 116. Once connected, the administrator portal 122 may receive a request from the patient device 118 including an email address used during pre-registration to create the patient record 102 for the patient. As another example, the request may include additional or alternate information provided on the enrollment card 132 given to the patient upon conclusion of the first visit of the patient to a physician utilizing the health system 100.

At operation 304, the administrator portal 122 determines whether the patient requires enrollment. For example, the administrator portal 122 may query the secure data store 110 to determine whether the patient record 102 corresponding to the information entered from the enrollment card 132 is set to the state of enrolled or un-enrolled. If the patient record 102 is set to the enrolled state, control passes to operation 312. Otherwise, control passes to operation 306.

At operation 306, the administrator portal 122 receives patient enrollment information. For example, the administrator portal 122 may prompt the patient for information via the patient portal 116. This information may include, for example, patient contact information such as addresses and phone numbers, patient billing information such as credit card or bank information, and security information such as passwords or pass-codes.

At operation 308, the administrator portal 122 provides the entered information to the secure data store 110 for storage. For example, the administrator portal 122 may direct the secure data store 110 to add the additional contact, billing and security information to the patient record 102 for the patient. The received information may be stored in an encrypted form in the secure data store 110. In some cases, the health system 100 may charge the patient for use of the health system 100 using the collected billing information. The administrator portal 122 may further direct the secure data store 110 to set the patient record 102 to the enrolled state.

At operation 310, the administrator portal 122 sends a welcome notification to the patient. For example, as the patient is now enrolled, the administrator portal 122 may utilize the notification module 128 to provide the welcome notification to an address of the patient (e.g., e-mail address), as indicated by the corresponding patient records 102. The notification may include instructions reminding the patient to take the next steps in utilizing the health system 100. These steps may include, for example, completing the questionnaire 104 as discussed in greater detail below.

At operation 312, the administrator portal 122 navigates the patient to the wellness site welcome page of the patient portal 116. For example, the welcome page of the patient portal 116 may include a landing page welcoming the patient to the health system 100 and outlining first steps for the patient (e.g., completing the questionnaire 104, perform the health assessment course 106, performing other courses 106, etc.).

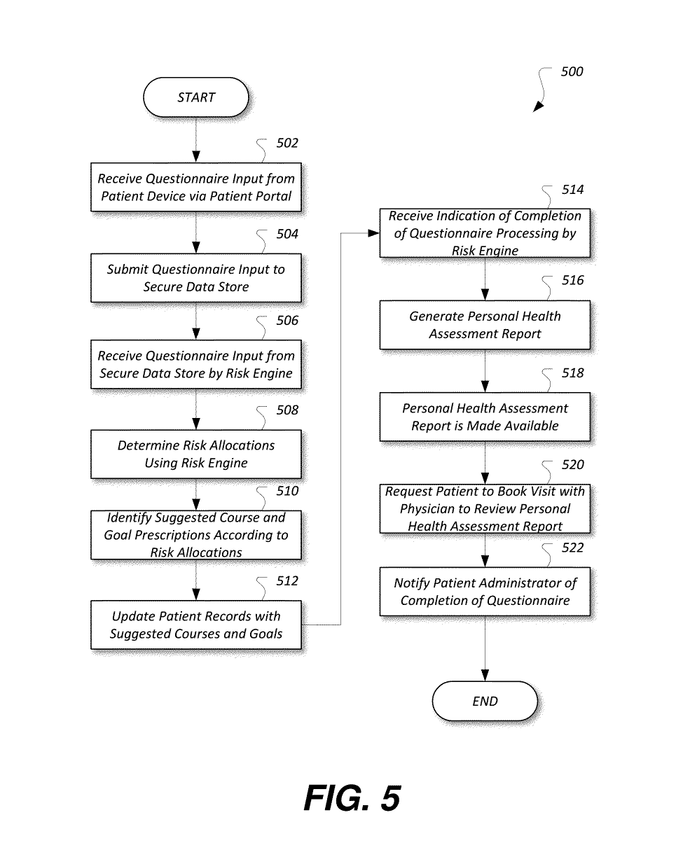

At operation 314, the administrator portal 122 determines whether the questionnaire 104 for the patient was completed. For example, the administrator portal 122 may query the secure data store 110 to determine whether the patient record 102 includes an indication that the questionnaire 104 was completed. If the patient record 102 indicates that the questionnaire 104 was completed, the process 300 ends. Otherwise, control passes to the process 500 discussed in detail below with respect to FIG. 5.

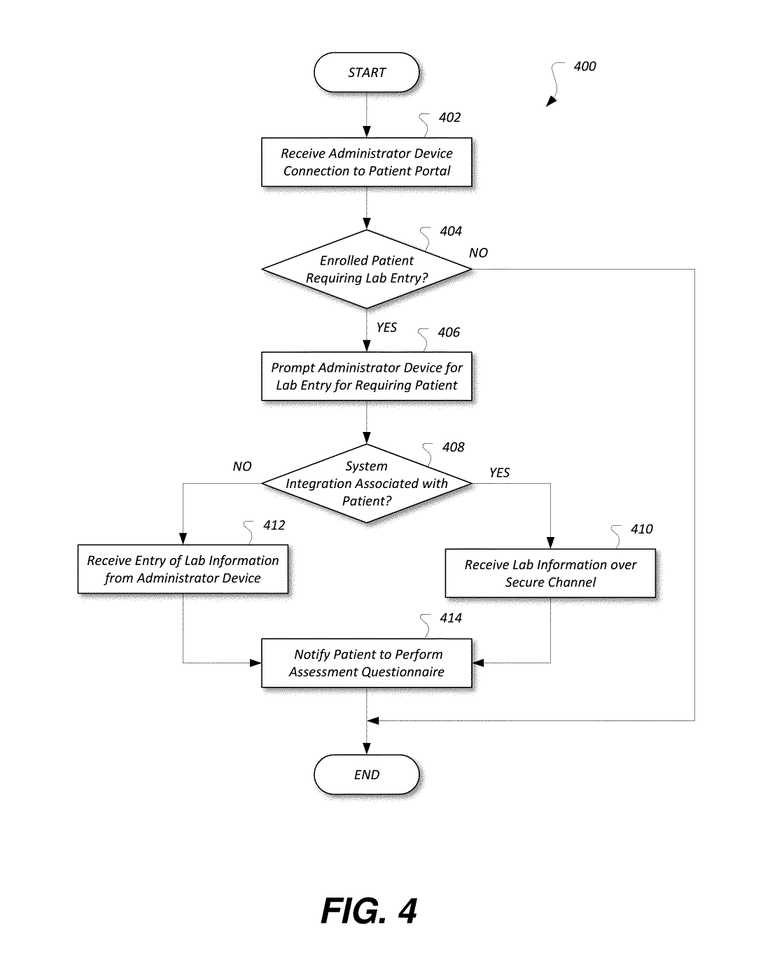

FIG. 4 illustrates a process 400 for updating health measures information for a patient using the health system 100. As with the process 200, the process 400 may be performed for example, by the administrator portal 122 of the web server 114 receiving input from the administrator device 124.

At operation 402, the administrator portal 122 receives an administrator device 124 connection to the administrator portal 122 of the web server 114. For example, the administrator portal 122 may receive a request from the administrator device 124 including login credential information for the physician office of which the administrator operating the administrator device 124 is associated.

At operation 404, the administrator portal 122 determines whether there are enrolled patients requiring laboratory result entry. For example, at a predetermined interval, the administrator portal 122 may query the secure data store 110 for patient records 102 that are enrolled but lack associated lab results in the patient records 102. If patient records 102 include enrolled patients requiring lab entry, control passes to operation 406. Otherwise, the process 400 ends.

At operation 406, the administrator portal 122 prompts the administrator device 124 to provide lab entry for the requiring patient records 102. For example, the administrator portal 122 may provide a listing of the or more identified patient records 102 in the administrator portal 122, and the administrator may select one of the requiring patient records 102 from the administrator portal 122.

At operation 408, the administrator portal 122 determines whether health system application integration is available for the selected patient record 102. For example, administrator portal 122 may utilize the configuration of the record provider for the patient to determine whether health system application integration is available. If health system application integration is available, control passes to operation 410. Otherwise, control passes to operation 412.

At operation 410, the administrator portal 122 receives the lab information over a secure communication channel. For example, the administrator portal 122 may utilize the health system application integration module 130 of the web server 114 to securely connect with and synchronize the health system 100 with the lab information associated with the patient of the patient record 102. The administrator portal 122 may accordingly receive the lab information, and provide the lab information to the secure data store 110 for storage in association with the corresponding patient record 102.

At operation 412, the administrator portal 122 receives the lab information from the administrator device 124. For example, the administrator portal 122 may provider an input form user interface (e.g., a quick entry dashboard) via the administrator portal 122. The administrator may accordingly access the current lab results for the patient from an in-office patient management system or other record system, and may enter the lab results into the health system 100. The administrator portal 122 may accordingly receive the lab information, and provide the lab information to the secure data store 110 for storage in association with the corresponding patient record 102.

At operation 414, the administrator portal 122 notifies the patient to perform the assessment questionnaire 104. The administrator portal 122 may utilize the notification module 128 of the web server 114 to provide the notification to an address of the patient (e.g., e-mail address), as indicated by the corresponding patient records 102. The notification may include instructions requesting the patient to access the patient portal 116 to perform the assessment questionnaire 104 to complete his or her initial health assessment. After operation 414, the process 400 ends.

FIG. 5 illustrates a process 500 for receiving health assessment information by the health system 100 using a questionnaire 104. As with the process 300, the process 500 may be performed for example, by the administrator portal 122 of the web server 114 receiving input to the patient portal 116 from the patient device 118. In some cases, the process 500 may be initiated responsive to the determination in operation 314 of process 300. In other cases, the process 500 may be initiated responsive to patient login to the patient portal 116 of the web server 114.

At operation 502, the administrator portal 122 receives questionnaire 104 input from the patient device 118 via the patient portal 116. For example, the administrator portal 122 may provide a data entry user interface through which the patient may respond to questions of the questionnaire 104.

At operation 504, the administrator portal 122 submits the questionnaire 104 input to the secure data store 110. For example, the patient may indicate via the patient portal 116 that the questionnaire 104 is complete. Responsive to the indication the administrator portal 122 may direct the secure data store 110 to store the questionnaire 104 information in association with the patient record 102 for the submitting patient.

At operation 506, the administrator portal 122 receives the questionnaire 104 input from the secure data store 110. For example, the risk engine 126 may be configured to periodically query the secure data store 110 for patient records 102 having questionnaire 104 information but no risk analysis information. As another example, the risk engine 126 may be invoked to generate risk analysis information for patient records 102 responsive to the administrator portal 122 receiving submission of questionnaire 104 information from a patient.

At operation 508, the administrator portal 122 determines risk allocations using the risk engine 126. For example, the risk engine 126 may determine risk associations for a set of possible health conditions for which information is requested from the patient via the questionnaire 104. The risk engine 126 may further utilize the patient screening information included in the patient record 102 in the determination of risk allocations. The risk associations may be indicative of the relative probability of the patient suffering from one of the set of possible health conditions. The risk engine 126 may further determine an overall score for the patient indicative of the overall level of health risk for the patient. As an example, the overall score may be indicative of an overall risk of the patient experiencing any of the health conditions.

At operation 510, the administrator portal 122 identifies suggested course 106 prescriptions and goal 106 prescriptions according to the risk allocations. In an example, the administrator portal 122 may identify which of set of possible health conditions is most likely to occur according to the determined risk associations, and may assign courses and goals 106 to address that most likely risk.

At operation 512, the administrator portal 122 updates the patient records 102 with the suggested courses and goals 106. For example, the administrator portal 122 may direct the secure data store 110 to save the suggested courses and goals 106, so that they may be made available for administrators to review via the administrator portal 122.

At operation 514, the administrator portal 122 receives an indication of completion of risk engine 126 processing of the patient records 102. For example, the risk engine 126 may inform the administrator portal 122 of completion of the determination of the suggested courses and goals 106. As another example, the administrator portal 122 may periodically query the secure data store 110 for patient records 102 having suggested courses and goals 106 associated that have not yet been approved by an administrator.

At operation 516, the administrator portal 122 generates a personal health assessment report. The personal health assessment report may include information that ties together the lab results and biometrics of the patient (e.g., as collected during the first visit and via the questionnaire 104) with lifestyle habit responses to suggest areas of health improvement (e.g., the assigned courses and goals 106 to address likely health risks).

At operation 518, the administrator portal 122 makes the personal health assessment report available. For example, the administrator portal 122 may utilize the notification module 128 of the web server 114 to provide the notification to an address of the patient (e.g., e-mail address), as indicated by the corresponding patient records 102. The notification may include instructions explaining to the patient how to view the personal health assessment report and generally what type of content the personal health assessment report contains.

At operation 520, the administrator portal 122 requests the patient to book a follow-up visit with the physician to review the personal health assessment report. For example, the administrator portal 122 may utilize the notification module 128 of the web server 114 to provide a message to the patient requesting that the patient schedule an appointment with the physician to review the results.

At operation 522, the administrator portal 122 notifies the patient administrator of completion of the questionnaire 104. For example, the administrator portal 122 may periodically (e.g., nightly) query the secure data store 110 for patient records 102 having completed health assessments, and may utilize the notification module 128 of the web server 114 to provide a notification to each physician/administrator to review the questionnaire 104 results before going over the personal health assessment report with the patient. After operation 522, the process 500 ends.

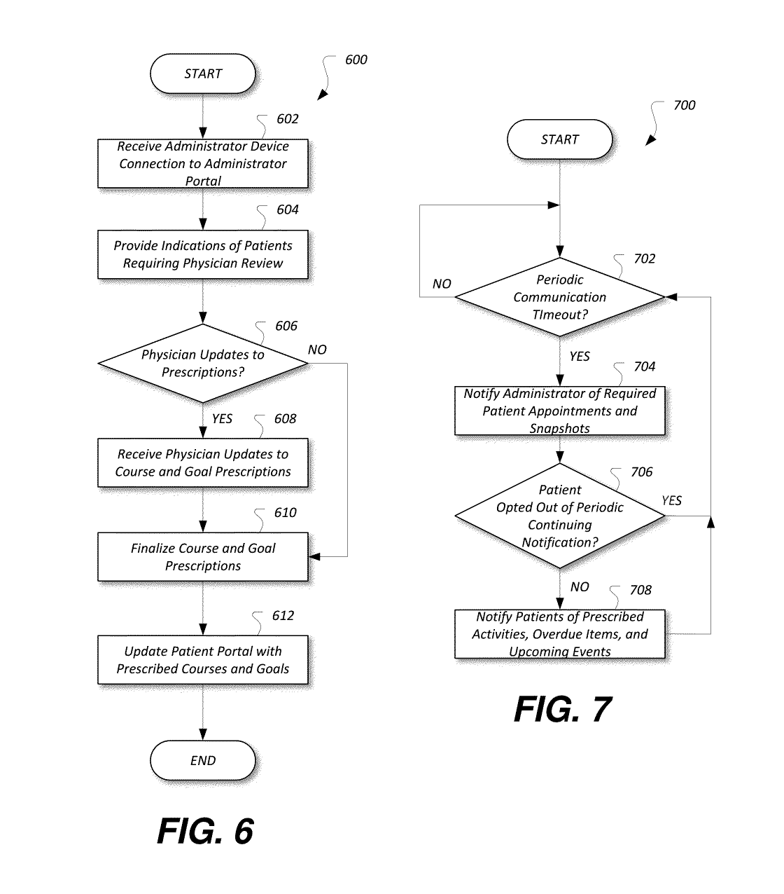

FIG. 6 illustrates a process 600 for reviewing and setting goals 106 using the health system 100. As with the processes 200 and 400, the process 600 may be performed by the administrator portal 122 of the web server 114 receiving input from the administrator device 124. The process 600 may be initiated, for example, by a patient visiting the physician office for the follow-up appointment to review the personal health assessment report. In another example, process 600 may be initiated by a patient virtually appearing for an appointment with the physician to review the personal health assessment report.

At operation 602, the administrator portal 122 receives an administrator device 124 connection to the administrator portal 122 of the web server 114. For example, the administrator portal 122 may receive a request from the administrator device 124 including login credential information for the physician office of which the administrator operating the administrator device 124 is associated.

At operation 604, the administrator portal 122 provides indications of patients requiring physician review. The administrator may accordingly utilize a dashboard of the administrator portal 122 to select an indication of the visiting patient to bring up the personal health assessment report for the patient. As another possibility, the administrator may utilize the administrator portal 122 to print a hardcopy of the personal health assessment report to review with the patient.

At operation 606, the administrator portal 122 determines whether the physician desires to provide updates to the suggested courses and goals 106 provisionally prescribed by the risk engine 126. For example, after review and discussion with the patient, the administrator may provide input the administrator portal 122 to indicate that adjustment to the courses and goals 106 is required, and control passes to operation 608. Or, the administrator may provide input the administrator portal 122 indicating that no adjustments are required, and control passes to operation 610.

At operation 608, the administrator portal 122 receives physician updates to the suggested courses and goals 106. For example, the administrator may provide input the administrator portal 122 to apply whatever adjustments to the courses and goals 106 the physician determines are necessary after the consultation with the patient.

At operation 610, the administrator portal 122 finalizes the course and goal 106 prescriptions. Accordingly, the course and goal 106 may be prescribed to the patient by the physician.

At operation 612, the administrator portal 122 updates the patient wellness site with the prescribed courses and goals 106. Thus, upon approval by the physician, the administrator portal 122 may make the prescribed courses and goals 106 available to the patient via the patient portal 116. Once prescribed, the patient may be able to complete their prescriptions at their leisure. The patient may accordingly update his or her status with the prescribed courses and goals 106 by logging into the patient portal 116, and inputting his or her results. These results may then be made available to the physician via the administrator portal 122, to allow the physician to track the progress of the patent through the courses, and to see whether the patient has met the goals. In some cases, the program may be reset periodically, such as on a yearly basis, regardless of whether the prescribed courses and goals 106 are achieved. After operation 612, the process 600 ends.

FIG. 7 illustrates a process 700 for ongoing communications with the patient using the health system 100. The process 700 may be performed by the administrator portal 122 to maintain communication between the physicians and patients via the health system 100.

At operation 702, the administrator portal 122 determines whether a periodic communication timeout has elapsed. For example, upon the periodic basis (e.g., weekly), the administrator portal 122 may determine that a periodic communication is due to the physician or the patient administrator. If so, control passes to operation 704. Otherwise, control passes to operation 706.

At operation 704, the administrator portal 122 notifies the administrator of required patient appointments and snapshots. For example, the administrator portal 122 may be configured to generate a periodic summary of the patients of the physician, and may utilize the notification module 128 to provide the periodic summary to the physician. The summary may include, for example, population counts of the patient counts and various generalized statistics relating to the patients of the physician. The summary may be configured, however, to exclude personal health information regarding the patients, such as names, birth dates, or other patient specifics.

At operation 706, the administrator portal 122 determines whether the patient has opted out of continuing notifications. For example, upon the periodic basis (e.g., weekly), the administrator portal 122 may determine that a periodic communication is due to the patient if the patient has not opted-out of continuing notification. If so, control passes to operation 708. Otherwise, control passes to operation 702.

At operation 708, the administrator portal 122 notifies the patient of prescribed activities, overdue items, and upcoming events. For example, the administrator portal 122 may be configured to generate a periodic summary of the patient activity, items, and events, and may utilize the notification module 128 to provide the periodic summary to the patient. Accordingly, by receipt of the continuing notifications, the patient may stay engaged with the health system 100. After operation 708, control passes to operation 702.

Thus, based on the initial health screening of the patient performed during a first visit (e.g., as discussed above with respect to the process 200), and input received based on the questionnaire 104 (e.g., as discussed above with respect to the process 500), the health system 100 may determine at least one course or goal 106 to be suggested to be prescribed to the patient. Once approved by the physician based on a follow-up visit with the patient (e.g., as discussed above with respect to the process 600), the patient may be able to log into the patient portal 116 to review and work on the prescribed courses and goals 106 at his or her leisure. The patient may accordingly update his or her status with the prescribed courses and goals 106 by logging into the patient portal 116, and inputting his or her results. These results may then be made available to the physician via the administrator portal 122, to allow the physician to track the progress of the patent through the courses, and to see whether the patient has met the goals. If no update is received within a predetermined amount of time, then the health system 100 may send a notification to the patient to return to the health system 100 (e.g., as discussed above with respect to the process 700).

In sum, by use of the health system 100, a physician may be able to monitor a patient to ensure wellness between visits. Using the health system 100, the patient may achieve an active relationship with his or her physician by enrolling in health programs to learn about his or her health and health conditions, track nutrition and physical activity, set personal health goals, and otherwise communicate with his or her physician. The health system 100 may also be managed by one or more system administrators, such as the physician or a nurse, clerk or another member of support staff, that may interact with the health system 100 to facilitate program activities.

Computing devices described herein, such as the database server 108, web server 114, patient device 118 and administrator device 124, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a computing device configured to
access a patient record including screening information indicative of vital signs of a patient and questionnaire information indicative of health history of the patient,
determine, using a risk engine based on the screening information and the questionnaire information, risk allocations for the patient that define a primary health risk of the patient, and
identify, according to the risk allocations, at least one online course and personal goal to be prescribed to the patient to reduce the primary health risk of the patient toward a health goal.

2. The system of claim 1, wherein the computing device is further configured to provide an administrator portal configured to receive input from a physician, and wherein the screening information is received via the administrator portal responsive to a first visit of the patient to the physician.

3. The system of claim 2, wherein the computing device is further configured to generate a personal health assessment report based on the screening information, the questionnaire information, and the risk allocations for the patient, the personal health assessment report summarizing the screening information and questionnaire information and suggesting areas of health improvement.

4. The system of claim 3, wherein the computing device is further configured to:
notify the patient, to an address of the patient retrieved from the patient record, to attend a follow-up visit to the first visit to review the personal health assessment report, and
receive, via the administrator portal based on the follow-up visit, physician approval of the at least one online course and personal goal.

5. They system of claim 2, wherein the computing device is further configured to provide a patient portal configured to receive input from the patient, the questionnaire information is received via the patient portal, and the questionnaire information is included in the patient record by the computing device responsive to the input to the patient portal.

6. The system of claim 5, wherein the computing device is further configured to:
receive approval from the physician for the at least one online course and personal goal via the administrator portal, and
update the patient record to include the at least one online course and personal goal on the patient portal.

7. The system of claim 6, wherein the computing device is further configured to:
receive, via the administrator portal, updates to the at least one online course and personal goal conditional to the approval from the physician, and
update the patient record to include the at least one online course and personal goal, as updated, on the patient portal.

8. The system of claim 5, wherein the computing device is further configured to:
receive, via the patient portal, status updates regarding progress of the patient with the at least one online course and personal goal, and
update the administrator portal to indicate the progress of the patient with the at least one online course and personal goal.

9. A system comprising:
a patient computing device configured to
provide, via a patient portal provided by a remote computing device to the patient computing device over a communication network, questionnaire information indicative of a health history of a patient,
receive, from the remote computing device, a notification to attend a follow-up visit to a physician office to review a personal health assessment report, generated by the remote computing device, based on the questionnaire information and screening information indicative of vital signs of the patient collected at an initial patient visit to the physician office, and
receive, via the patient portal, at least one online course and personal goal prescribed to the patient by the physician to reduce a primary health risk of the patient, the at least one online course and personal goal determined based on the questionnaire information, the screening information, and input from the physician responsive to the initial patient visit and follow-up visit.

10. The system of claim 9, wherein the at least one online course and personal goal including a measure of an objective health parameter for the patient to achieve.

11. The system of claim 10, wherein the objective health parameter for the patient includes a goal for at least one of weight, calorie intake, exercise, and resting heart rate.

12. The system of claim 10, wherein the at least one online course and personal goal includes a course to be provided via the patient portal including at least one of: suggested actions to be performed by the patient, and information to be provided to the patient to help the patient in achieving the measure of the objective health parameter.

13. The system of claim 9, wherein the patient portal includes branding identifying the patient portal as associated with the physician office.

14. A system comprising:
an administrator computing device configured to
receive, via an administrator portal provided by a remote computing device to the administrator computing device over a communication network, information indicative of at least one online course and personal goal suggested by the remote computing device to be prescribed to a patient to reduce a primary health risk of the patient toward a health goal, and
provide, via the administrator portal, physician approval of the at least one online course and personal goal to be prescribed to the patient, to cause the remote computing device to update a patient portal, provided by the remote computing device to a patient computing device over the communication network, to indicate that the at least one online course and personal goal are prescribed to the patient.

15. The system of claim 14, wherein the administrator computing device is further configured to provide, via the administrator portal, updates to the at least one online course and personal goal received from the physician.

16. The system of claim 14, wherein the remote computing device is further configured to:
determine, using a risk engine based on screening information indicative of vital signs of a patient and questionnaire information received via the patient portal, risk allocations for the patient that define the primary health risk of the patient, and
identify, according to the risk allocations, the at least one online course and personal goal to be prescribed to the patient to reduce the primary health risk of the patient toward the health goal.

17. The system of claim 16, wherein the administrator computing device is further configured to:
receive an input interface via the administrator portal for input of the screening information, and
provide, via the input interface, the screening information indicative of vital signs of the patient collected at a visit of the patient to the physician.

18. The system of claim 16, wherein the administrator computing device is further configured to receive, via the administrator portal, a personal health assessment report generated by the remote computing device based on the screening information, questionnaire information, and risk allocations for the patient.

19. The system of claim 14, wherein the administrator computing device is further configured to receive, via the administrator portal, information indicative of progress of the patient with the at least one online course and personal goal.
